(19) United States
(12) Patent Application Publication
(10) Pub. No.: US 2009/0078157 A1
(43) Pub. Date: Mar. 26, 2009

(54) Inorganic sheet materials

(75) Inventors: John Wihelm Geus, Bilthoven (NL); Jacobus Berend Dirksen, Almere (NL)

Correspondence Address: WEINGARTEN, SCHURGIN, GAGNEBIN & LEBOVICI LLP, TEN POST OFFICE SQUARE, BOSTON, MA, 02109, US

(73) Assignee: Eurosupport B.V., Amersfoort (NL)

(21) Appl. No.: 11/919,849

(22) PCT Filed: May 1, 2006
(86) PCT No.: PCT/NL2006/000233

§ 371 Date: Nov. 12, 2008

(30) Foreign Application Priority Data
May 2, 2005 (NL) 1028936

(51) Int. Cl. B32B 5/16; B01J 20/10; B01J 21/06; C04B 14/04; C08K 3/00; C08K 3/34

(52) U.S. Cl. 106/431; 428/331; 428/328; 428/330; 502/407; 502/240; 502/241; 502/244; 502/255; 502/258; 502/260; 502/253; 502/259; 502/200; 106/457; 106/467; 524/443; 524/450

(57) ABSTRACT

The invention is directed to a synthetic inorganic material, comprising inorganic compounds based on elementary particles with a sheet (phyllosilicate) structure, the elementary particles consisting of a central layer of octahedrally coordinated divalent metal ions between two layers of tetrahedrally surrounded silicon ions, which particles are substantially free of aluminum, free silica and salts and hydroxides of the divalent metal ions, the material not containing any metal ions that can be reduced to the corresponding metals at temperatures of 700° C. or less.

The invention relates to inorganic sheet materials that are suitable for various applications, such as supports for catalytically active materials, for absorbents, for fillers for polymers, for the manufacture of interference pigments and the like. In general, it may be stated that the catalytic reaction in case of a solid catalyst proceeds on the surface of the catalytically active material. Accordingly, in principle, the catalytic activity is proportional to the surface of the active component per unit volume of the catalyst. This leads to two different situations. When the catalytic reaction is not extremely fast and the catalytically active material is relatively cheap, the size of the reactor needed to accomplish a particular production capacity is of critical significance. The aim is then for a maximum catalytically active surface per unit volume of catalyst. In case of a costly catalytically active material, as with platinum, palladium or rhodium, the investment in the catalyst is dominant. Now, the aim will be for a maximum surface per unit weight of the catalytically active component. In both of the above cases, attempts will be made to achieve a catalytically active surface of typically tens of m² per m³ of catalyst volume. Clearly, this is only possible by dividing the catalytically active material extremely finely.

By way of example, we take 1 cm³ of nickel, which is 8.9 grams of nickel. The surface of 1 cm³ of nickel is 6×10⁻⁴ m². If we divide 1 cm³ of nickel into cubes having a rib of 1 μm, this leads to 10¹² cubes having a total surface of 6 m². If 1 cm³ of nickel is divided into cubes having a rib of 0.01 μm, that is 10 nm, the resultant nickel surface is 600 m². However, finely divided material cannot be straightforwardly used as catalyst. Depending on the manner in which the catalyst is contacted with the reactants, a minimum dimension of catalyst bodies is to be taken into account. When a fixed catalyst bed is used, separation of the catalyst from the reaction products is extremely simple to carry out in a technical manner. However, this imposes limitations on the pressure drop sustained by the flow of reactants upon passage through the catalyst bed. If this pressure drop is too high, the catalyst is blown from the reactor. Technically speaking too, one is generally bound to a pressure drop that is not too high, even before coming to values for the pressure drop at which the catalyst is transported from the catalyst bed. In general, it may be stated that a solid catalyst can be used as bodies having an equivalent diameter of at least about 1 mm in fixed catalyst beds (the equivalent diameter is the diameter of a sphere having the same surface/volume ratio as the catalyst bodies). Clearly, in the use in a fixed catalyst bed, the catalyst is to be used as porous bodies having a dimension of at least 1 mm if the required catalytically active surface per unit volume is to be made available. If the catalyst is used in a fluidized bed, a particle size distribution of the catalyst with dimensions of 70 to 120 μm is often technically most attractive. These dimensions are not compatible either with the required catalytically active surface per unit volume of catalyst, so that also when using the catalyst in a fluidized bed, porous catalyst bodies are used. As a last possibility of contacting the catalyst with the reactants, we mention here a catalyst suspended in a liquid which contains at least one of the reactants. What is dominant in that case is the possibility of separating the catalyst from the liquid by settling, filtration or centrifugation. For this purpose, catalyst particles must be used having a minimum dimension of approximately 3 μm. In this case, too, porous bodies need to be used to obtain the necessary catalytically active surface per unit volume.

When using such porous bodies as catalyst, not only the size of the catalytically active surface per unit volume of catalyst is determinative of the catalytic activity, but also the accessibility of the active surface. The reacting molecules need to migrate through the pores of the porous body to reach the catalytically active sites. Both the transport in the gaseous phase or liquid phase to the external surface of the catalyst bodies and the transport in the pores of the catalyst bodies can determine the effective velocity of the catalytic reaction. To enlarge the external surface of the porous catalyst bodies, the catalyst is often applied after shaping into rings instead of cylinders which are easier to manufacture. Also, the catalyst is often processed to form trilobes or quadrilobes, whereby the external surface is greatly enlarged. When using trilobes or quadrilobes, also the average length of pores in the catalyst bodies is reduced. This increases the effective velocity of the catalytic reaction more than increasing the diameter of pores, although that too is of benefit to the velocity of the transport of reactants. For the evaluation of the influence of the transport of reactants in porous catalyst bodies, the so-called Thiele modulus is used. This modulus features the length of the pores and the square root of the diameter of pores, which indicates that the average length of pores has a greater influence on the effective reaction velocity.

For a proper action of a solid catalyst, therefore, not only the chemical composition of the catalytically active material is important, but also the shape and dimensions of the catalyst bodies, the external surface, the (internal) accessible surface and the pore volume of the catalyst bodies as well as the average dimension of pores in the catalyst bodies. Finally, the mechanical strength of catalyst bodies in most cases is the factor that determines whether a catalyst is technically useful. Upon pulverization of a fixed bed catalyst when loading into the reactor or during use, the pressure drop runs up unduly high. Also, the flow of reactants through the catalyst bed often becomes inhomogeneous, which can lead to highly undesirable results. In a fluidized bed, strong wear of catalyst particles is absolutely unallowable. The catalyst then cannot be separated from the flow of reaction products anymore. Also in the case of catalysts suspended in liquids, wear of the catalyst particles is not permitted. Separation of the sometimes costly catalyst from the reaction products is then no longer possible through filtration, sedimentation or centrifugation. Often more laborious procedures need to be used then.

Mostly, it is not possible to process a solid substance that exhibits the required catalytic activity and selectivity into porous bodies having the requisite mechanical strength, shape and dimensions, pore volume, and catalytically active surface per unit volume. As a consequence, in virtually all cases, with solid catalysts, so-called catalyst supports are used. The use of a catalyst support leads to a separation of functions. The catalyst support provides the requisite mechanical strength, shape and dimension of the catalyst bodies, as well as pore volume and accessible surface. The catalytically active component(s) provided on the surface of the support bodies provide the required catalytic activity and selectivity. Support materials are used especially in the case of costly catalytically active components, such as precious metals. In that case, the aim is to have as many atoms of the active material as possible at the surface. This is achieved by providing the active component on the surface of a suitable support as particles having dimensions of up to approximately 1 nm. In that case, one has no less than 90% of the atoms of the catalytically active compound at the surface, so that they can participate in the catalytic reaction.

For a long time now, a limited number of catalyst supports have been used technically, with hardly any new developments occurring. In general, if a support material with a large surface is needed, the first choice is γ-aluminum oxide. This material has a relatively high bulk density, so that much catalytically active material can be provided in a unit of volume of the reactor. The accessible surface of customary γ-aluminum oxide as support material varies from 100 to approximately 450 m² per gram. The accessibility of the surface cannot be set properly. By starting, in the preparation of the 7-aluminum oxide, from pseudoboehmite, a material whose elementary particles have a needle-shaped structure, the accessibility of the surface can be improved to some extent. A drawback of γ-aluminum oxide is the fact that the material is soluble in acid liquids. Also in liquids having a high pH value, 7-aluminum oxide dissolves as aluminate. Another drawback is that the γ-aluminum oxide tends to react with precursors of catalytically active components to form aluminates with a spinel structure. Most well-known is the reaction with cobalt oxide to form cobalt aluminate, CoAl₂O₄. In this compound, the cobalt can hardly be reduced to the metal. As a result, it is difficult to use γ-aluminum oxide as support for metallic cobalt. It has successfully been managed to suppress the reaction of the cobalt oxide with the aluminum oxide by applying a layer of silicon dioxide. However, this requires an extra preparatory step. With nickel oxide, too, γ-aluminum oxide reacts to form the corresponding spinel, the nickel of which is difficult to reduce to the metal. However, the γ-aluminum oxide can be well extruded and otherwise processed into strong shaped bodies.

The other support material that is frequently used is silicon dioxide. This material is cheap and on the market in many variants. A drawback of silicon dioxide is the lower bulk density, so that the catalytically active surface per unit volume of catalysts with silicon dioxide as support is generally lower than that of catalysts with γ-aluminum oxide as support. Silicon dioxide does not dissolve in acid liquids, but does dissolve in alkaline liquids. Also, silicon dioxide often reacts with precursors of catalytically active components to form compounds in which the metal ion is difficult to reduce to the corresponding metal. However, the reduction of such compounds proceeds much more readily than that of the spinels that are formed with γ-aluminum oxide. A major drawback of silicon dioxide is the fact that the material volatilizes at elevated temperature in high-pressure steam as Si(OH)₄. Extrusion of silicon dioxide can present problems, but even so it has successfully been managed to bring a variety of shaped porous bodies of silicon dioxide on the market.

Of both γ-aluminum oxide and silicon dioxide, it is difficult to control the pore structure. Problematic in particular is the production of support bodies having a relatively large pore volume and yet a high mechanical strength. In relatively fast catalytic reactions, where a relatively slow transport adversely affects the selectivity, the fact that the porous structure cannot be set is a fundamental drawback. In such cases, support bodies having a large pore volume and a high mechanical strength would be extremely important. In general, however, a large pore volume is attended by a low mechanical strength, so that such support materials, despite the existing need, are not commercially available.

For liquid phase reactions, often activated carbon is used as support. First of all, this support is resistant to (strongly) acidic and alkaline liquids. Furthermore, when using precious metals as catalytically active component, activated carbon is an attractive support. Through simple combustion of the carbon, the costly precious metal can be readily recovered. On the other hand, activated carbon has a large number of drawbacks. First of all, the mechanical strength of activated carbon bodies is often a problem. Furthermore, it is very difficult to control the porous structure of bodies of activated carbon.

Currently, work is also being done on the development of support materials based on titanium dioxide and zirconium dioxide. Such support materials are resistant to alkaline solutions, which is attractive, for instance, in the hydrogenation of nitrites. This hydrogenation is typically carried out in (strongly) ammoniacal solutions. Also with supports based on these materials, it is virtually impossible to control the pore structure.

It may therefore be concluded that, certainly for carrying out catalytic reactions where the selectivity is of critical importance, a clear need exists for support materials whose pore structure can be set better. Especially, there is a need for supports from which shaped bodies can be produced having a porous structure that can be well controlled without affecting the mechanical strength of the support bodies.

Virtually analogous requirements to those imposed on heterogeneous catalysts are imposed on solid absorbents with which compounds such as hydrogen sulfide, mercaptans, sulfur dioxide and an element such as mercury are removed from gas flows. Also with solid absorbents, it is important to obtain a large surface of the absorbing material per unit volume, while this surface needs to be properly accessible from the gaseous phase. In connection with the allowable pressure drop across the bed of the absorbent, also the processability to mechanically strong bodies is of great importance. In U.S. Pat. No. 5,320,992 (1994) it is proposed to provide an absorbent based on iron oxide, finely divided, on natural montmorillonite. A drawback of natural montmorillonite is that it is difficult to control the stacking of the clay sheets, so that the surface of the montmorillonite is limited. Also, the accessibility of this surface is difficult to set.

The invention accordingly concerns synthetic inorganic materials, comprising inorganic compounds based on elementary particles with a sheet (2:1 phyllosilicate) structure, the elementary particles consisting of a central layer of octahedrally coordinated divalent metal ions between two layers of tetrahedrally surrounded silicon ions, which particles are substantially free of aluminum, free silica and salts and hydroxides of the divalent metal ions, the material not containing any metal ions that can be reduced to the corresponding metals at temperatures of 700° C. or less.

Core of the invention is a substantially non-swellable or only slightly swellable material having a 2:1 phyllosilicate structure, which is based on more or less stoichiometric amounts of divalent metal and silicon. In the tetrahedral and octahedral layers, there is substantially no substitution involved of the silicon and the divalent ions. In practice, this means that less than 1 at. % is substituted.

The divalent metal must not allow of reduction with H₂ at a temperature of 700° C. or less. This means that metals such as copper, nickel or cobalt are not eligible. It is noted in this connection that the term ‘ion’ indicates the use of metal or silicon in a crystal lattice, the valency of the various atoms being such as to theoretically involve a divalent valency for the metal ions and a tetravalent valency for the silicon. Hence, covalent contribution to the chemical bond in the phyllosilicate structure is not taken into account here.

According to the invention, such materials are preferably obtained by shaping bodies from inorganic compounds which consist wholly or substantially wholly of elementary particles which have a sheet structure based on that of phyllosilicates and of which the elementary sheets are not, or only slightly, electrostatically charged, while the materials according to the invention do not contain any metal ions that can be reduced to the corresponding metals at temperatures below approximately 700° C. Wholly or substantially wholly consisting of elementary particles having a sheet structure means that the material according to the invention does not contain hydroxides, (basic) carbonates, or oxides, but consists (substantially) completely of particles having the structure of phyllosilicates. According to a special form of the material according to the invention, in the octahedral layer, iron (II) ions, zinc ions or magnesium ions or a mixture of two or three of these ions are used.

It has been found that the phyllosilicates according to the invention are also eminently useful as fillers for polymers. It has been found that such sheet-shaped fillers can very efficiently suppress the migration of softeners and pigments in polymers. Moreover, it is possible by incorporating sheet-shaped solids into polymers to raise the glass temperature considerably. Interaction of the polymer molecules with the sheet-shaped inorganic particles leads to a higher glass temperature.

Although for this purpose sheets of natural clay minerals have been proposed, this application entails major drawbacks. It is difficult to purify natural clay minerals of impurities, especially of impurities with an asbestos structure. According to the current state of the art, this is done by reducing the dimensions of the natural clay minerals to a few μm's and to suspend the thus obtained powder in water. In U.S. Pat. No. 4,176,090 such a procedure is described.

Also, the materials are eminently useful to improve the wear resistance of the surface of polymers.

Another application involves the use in interference pigments, as substrate for metal oxides.

Synthetic clay materials prepared according to the invention can be readily prepared in a very pure form, without necessitating any prolonged hydrothermal synthesis. Also, the shape and dimensions of the clay sheets can be controlled well. Also exfoliation, the breaking up of stacked layers of clay sheets, is readily possible with clay minerals according to the invention.

Phyllosilicates occur as natural minerals. The structure of phyllosilicates has a central layer of divalent or trivalent metal ions which are octahedrally surrounded by oxygen ions. A limited number of these oxygen ions are present as hydroxyl ions. On two sides, this central layer is surrounded by a layer of silicon ions which are tetrahedrally surrounded by oxygen ions. In most phyllosilicates that occur in nature, the sheets built up from three layers are electrostatically charged. The electrostatic charge comes about in that lower-valency metal ions or vacancies are incorporated in the octahedral layer or in that a part of the silicon in the tetrahedrally surrounded layers has been replaced with trivalent positive ions. The negative electrostatic charge is neutralized in that between the sheets built up from three elementary layers, positive ions are included. Upon hydration of these positive ions in the intermediate layers, the phyllosilicate starts to swell; the distance of layers increases as a result of the take-up of water molecules. Hence the term swellable or swelling clay minerals. The positive ions in the intermediate layer can also be exchanged for other ions. Although upon reaction with acids the clay minerals are mostly affected and the metal ions from the octahedrally surrounded layer dissolve for a greater or lesser part, it is possible by a different route to replace the metal ions in the intermediate layer by (hydrated) protons. Mostly, this is done by first exchanging the metal ions for ammonium ions and subsequently decomposing the ammonium thermally, whereby ammonia escapes and a proton remains. It has long been known that swellable clay minerals pretreated in this way can be used as solid acid catalysts.

Until recently, invariably, natural clay minerals were used as solid acid catalysts, since the synthesis of clay minerals was difficult. Clay minerals could be synthesized only by hydrothermal route, at high temperatures and pressures, in prolonged operations. Comparatively recently, this has changed. In the patent specification WO9607613 (corresponding patent specification U.S. Pat. No. 6,187,710) a procedure is described of synthesizing swellable clay minerals within a relatively short time under atmospheric or slightly increased pressure. In this procedure, aluminum ions are incorporated in replacement of silicon ions in the tetrahedrally surrounded layers. The patent specification WO9607477 (corresponding patent specification U.S. Pat. No. 6,334,947) describes the combination of such swellable clay minerals with a hydrogenation catalyst. Later, it was decided that the alkali metal content of the synthesized swellable clay minerals was difficult to lower. The patent specification EP 1,252,096 (corresponding patent specification U.S. Pat. No. 6,565,643) for that reason mentions that the starting material is amorphous silicon dioxide/aluminum dioxide, a combination which is also used in the cracking catalysts for petroleum fractions.

The material according to the invention is distinguished from the above-discussed swellable clay minerals in that the layers, in principle, are not or only slightly electrostatically charged. Accordingly, the material according to the present invention is not or only slightly swellable, whilst exchange of intermediate layer ions for ammonium ions and conversion of the ammonium ions into ammonia and (hydrated) protons is hardly, if at all, possible.

Through the presence of vacancies in the octahedral layer, the clay sheets are electrostatically charged to a slight extent. As a result, the sheets are hydrophilic and swellable to a slight extent. It is incidentally noted that through the positive charge of the side of the elementary sheets and the negative charge of the surface of the sheets, the sheets are generally stacked only little during the synthesis. For exfoliation of the clay sheets, this is a great advantage.

An important difference with respect to the solid acid materials according to EP 1,252,096 is therefore that the materials according to the invention do not contain aluminum.

The materials according to the invention have a 2:1 structure, which means that one octahedral layer of divalent metal ions is surrounded by two SiO₅(OH) layers. The greater part of the known synthetic materials have a 1:1 structure.

Another aspect of the materials according to the invention is that they do not contain any F, nor need to be prepared in or from an F-containing reaction medium. It is possible to prepare the materials in a simple manner (as will be elucidated in more detail hereinafter) through precipitation from aqueous solutions of the various components, without the use of HF or other fluorine compounds being necessary.

According to the invention, the porous structure of the material is controlled by setting the lateral dimensions and the relative arrangement of the sheets. In this way, the accessible surface and the porous structure of the material according to the invention may be varied within wide limits.

According to the prior art, it is known to incorporate a precursor of a catalytically active metal in phyllosilicates and to simultaneously provide this precursor on the surface of the phyllosilicates. This method is most well-known for nickel catalysts supported on silicon dioxide. Upon reduction, the precursor provided on the phyllosilicate structure is converted into the catalytically active metal, while the metal ions incorporated in the phyllosilicate structure are also wholly or partly reduced. Since metal ions provided on the phyllosilicate structure are reduced much more easily than the metal ions included in the phyllosilicate structure, it is difficult in this way to accomplish a high degree of reduction and hence a high degree of utilization of the metal. The material according to the invention can contain cheap metal ions, such as magnesium or iron, while the more expensive catalytic precursor (for instance nickel, cobalt or other transition metals) is provided wholly on the surface in a readily reducible form. As a result, the degree of utilization of the expensive catalytically active component is much higher than with catalysts of a phyllosilicate structure according to the existing state of the art.

According to a first embodiment of the preparation according to the invention, the material is obtained by adjusting a suspension of silicon dioxide particles in a solution of the divalent metal ions to be incorporated in the octahedrally surrounded layer to a temperature above approximately 60° C. and to increase the pH homogeneously to a value above approximately 5.5; after complete or substantially complete precipitation of the divalent metal, separating the resultant solid material from the liquid, washing, drying, and optionally thermally pretreating it at a temperature of approximately 700° C. at a maximum. The ratio of silicon dioxide/metal ions is chosen such that (substantially) all silicon dioxide reacts to form material with the structure of phyllosilicate, while no hydroxide or basic carbonate of the metal ions to be incorporated precipitates.

The arrangement of the elementary sheets in the solid material separated from the liquid depends on the ion strength of the liquid during and after the precipitation. At a high ion strength, the sheets are arranged in a less open structure than at a low ion strength. A high ion strength during the precipitation is achieved according to the invention by raising the pH by injection of a solution of an alkali metal hydroxide or an alkali metal carbonate into the suspension of the silicon dioxide. According to a special method according to the invention, a nitrite of an alkali metal is dissolved in the solution in which the silicon dioxide is suspended, after which the suspension is heated to above approximately 60° C. in an inert gas which contains no molecular oxygen. The nitrate disproportions to nitrogen oxide (NO) and nitrate, whereby hydroxyl ions are formed. A low ion strength during the precipitation is obtained according to the invention by raising the pH with ammonia or ammonium carbonate. At the elevated temperature at which the precipitation is carried out according to the invention, the ammonia escapes, so that the ion strength of the solution remains low. According to a special form of the first method according to the invention, the pH is raised through hydrolysis of urea or of an analogous compound. In that case, the pH of the solution is raised completely homogeneously in that the mixing can be done at a low temperature, where the urea does not hydrolyze appreciably yet, while in the homogeneous solution, as a result of hydrolysis of the urea, the pH increases.

The lateral dimension of the sheets is set according to the invention in two ways. First of all, the temperature at which the precipitation of the divalent metal is carried out determines the dimension of the sheets. At a higher temperature, larger sheets are obtained. According to a special embodiment of the preparation according to the invention, work is done under hydrothermal conditions. The precipitation time has been found to decrease strongly when working under hydrothermal conditions, so that the production rate is increased. According to the invention, the dimension of sheets can be controlled to a greater extent by the choice of metal ions to be incorporated into the octahedrally surrounded layer. Thus, it has been found, surprisingly, that incorporation of magnesium ions leads to extremely small sheets (for instance 0.01 μm) and incorporation of zinc ions to large sheets (for instance 1.0 μm). It is also surprising that carrying out the precipitation in a solution in which magnesium ions and zinc ions occur side by side leads to sheets having intermediate dimensions. In the octahedral layer of the resulting material, zinc and magnesium ions then occur side by side.

If it is desired to prepare the material at a high ion strength of the liquid, it is possible, with advantage, to start from a water glass (alkali metal silicate) solution. This solution, simultaneously with a solution of the divalent metal ions to be incorporated into the phyllosilicate structure, can, with vigorous agitation, be injected through two separate tubes into water. In this preparation, the water is preferably held at a temperature above 60° C. Van Eijk van Voorthuijsen and Franzen have described the preparation in this way of phyllosilicates with nickel in the intermediate layer. Upon heating in a hydrogen flow at a temperature below 500° C., a considerable part of the nickel is reduced to metallic nickel (J. J. B. van Eijk van Voorthuijsen and P. Franzen Rec. Trav. Chim. Pays Bas 69 (1950) 666-667 and 70 (1951) 793-812). In most cases, the material obtained by the above authors contained silicon dioxide that had not been converted with nickel ions in the phyllosilicate. This also holds for the materials that Strese and Hofmann obtained when mixing water glass and magnesium containing solutions (H. Strese and U. Hofmann, Z. anorg. allgem. Chem. 247 (1941) 65).

Shaping can be eminently done by extruding, tabletting or spray-drying the phyllosilicate structures. According to the state of the art, with spray-drying, bodies having dimensions of a few tenths of millimeters to a few micrometers can be produced. A special form of spray-drying according to the known state of the art, in which for instance a rotating disc is used, makes it possible to manufacture, by spray-drying, bodies having dimensions of less than 10 μm. Regardless of the shaping process, after a thermal treatment at a temperature of approximately 400° C., mechanically extremely strong bodies are obtained, while porosity can be high depending on the starting material.

Catalytically active components or absorbents can be provided on the surface of the support materials according to the invention prior to shaping but also after shaping into bodies of the desired shape and dimensions. Precipitation of active precursors or absorbents from homogeneous solution can be carried out without separating the support material according to the invention from the liquid and drying it. The precursor of the active component to be provided on the support is dissolved in the liquid and the precipitation is carried out in the desired manner according to the known state of the art. Naturally, it is also possible first to separate the support material from the liquid and wash it, and then to suspend the material in a solution of the active precursor to be provided on the surface of the support or the absorbent to be provided. Next, the active precursor is precipitated according to the known prior art on the surface of the support.

Naturally, it is also possible first to shape the support material according to the invention and then to load it with a precursor of the catalytically active component or the absorbent. According to a special form of the method according to the present invention, the precursor of the active component is provided through impregnation with a suitable solution of a precursor, followed by drying and calcination. Preferably, impregnation is done according to the present invention with a solution of a precursor of the active component whose viscosity does not decrease upon evaporation of the solvent by drying and, more preferably, with a solution whose viscosity increases upon the evaporation. According to the current state of the art, it is known to work with solutions of citrate salts or analogous salts. Also, compounds such as hexaethylcellulose or polysaccharides can be added to the solution of the active precursor to be impregnated to accomplish an increase of the viscosity during drying.

The invention is elucidated in and by the following examples:

### Preparation of Supports for Catalysts and Absorbents and Fillers for Polymers by Hydrolysis of Urea.

### Preparation of an Iron(II) Containing Phyllosilicate.

The starting material was an amount of deionized water of 1 m³, in which 108 kg of urea (1.8 kmol) were dissolved. In the water, 60.1 kg of silicon dioxide were suspended (1.0 kmol). Next, 166.7 kg of Fe(II)SO₄.7H₂O (0.6 kmol) were dissolved in the water. After this, a flow of oxygen-free nitrogen was passed through the suspension to prevent oxidation of the iron (II). With intensive stirring, the suspension was heated at 90° C.; the hydrolysis of urea proceeds at this temperature with a considerable velocity, so that the pH of the suspension starts to rise. At the thus obtained pH, the reaction of iron (II) ions with the suspended silicon dioxide proceeds, whereby the desired phyllosilicate structure is formed. After all of the silicon dioxide and the dissolved iron (II) have reacted, as can be determined by analysis of a filtrate of the reaction mixture, the pH of the suspension runs up further to a level of 7.5 to 9.0. The reaction is then stopped by cooling the suspension. The obtained solid material is separated from the liquid in a filter press and washed thoroughly. The moist filter cake is finally dried at 120° C. for 10 hours.

### Preparation of a Zinc Containing Phyllosilicate.

The starting material was an amount of deionized water of 1 m³, in which 108 kg of urea (1.8 kmol) and 172.4 kg of ZnSO₄.7H₂O (0.6 kmol) were dissolved. In the water, 60.1 kg of silicon dioxide were suspended (1.0 kmol). With intensive stirring, the suspension was heated at 90° C. After all dissolved zinc ions and silicon dioxide have reacted and the pH has run up to a value of 7.5 to 9.0, the suspension is allowed to cool to room temperature. The obtained solid material is separated from the liquid in a filter press and washed thoroughly. The moist filter cake is finally dried at 120° C. for 10 hours.

### Preparation of a Magnesium Containing Phyllosilicate.

The starting material was an amount of deionized water of 1 m³, in which 108 kg of urea (1.8 kmol) and 147.8 kg MgSO₄.7H₂O (0.6 kmol) were dissolved. In the water, 60.1 kg of silicon dioxide were suspended (1.0 kmol). With intensive stirring, the suspension was heated at 90° C. After all dissolved magnesium ions and silicon dioxide have reacted and the pH has run up to a value of 7.5 to 9.0, the suspension is allowed to cool to room temperature. The obtained solid material is separated from the liquid in a filter press and washed thoroughly. The moist filter cake is finally dried at 120° C. for 10 hours.

The following table gives an overview of the properties of the above-obtained materials

| | | | Average pore diameter, | | | |
|---|---|---|---|---|---|---|
| | BET | PV—N₂ = pore volume in | calculated from BET | Metal content | | |
| | surface*⁾ | pores of diameters < | and PV—N₂ = | expressed as | Metal content | SiO₂ content |
| Example | m²/g | 200 nm*⁾ ml/g | 4000*PV—N₂/BET nm | the content of: | wt. % | wt. % |
| Fe—U | 365 | 0.67 | 7.3 | Fe₂O₃ | 46.4 | 53.0 |
| Zn—U | 297 | 0.67 | 9.0 | ZnO | 46.0 | 52.7 |
| Mg—U | 372 | 1.04 | 11.2 | MgO | 15.9 | 83.7 |

*⁾From N₂ adsorption, 3 point determination

1. A synthetic inorganic material, comprising inorganic compounds based on elementary particles with a sheet (2:1 phyllosilicate) structure, the elementary particles consisting of a central layer of octahedrally coordinated divalent metal ions between two layers of tetrahedrally surrounded silicon ions, which particles are substantially free of aluminum, free silica and salts and hydroxides of said divalent metal ions, the support material not containing any metal ions that can be reduced to the corresponding metals at temperatures of 700° C. or less.

2. A material according to claim 1, wherein the content of said salts and hydroxides of divalent metal ions is less than 10 wt. %, preferably less than 1 wt. % of the support material.

3. A material according to claim 1, wherein the content of free silica is less than 10 wt. %, preferably less than 1 wt. % of the support material.

4. A material according to claim 1, wherein the content of aluminum is less than 10 wt. %, preferably less than 1 wt. % of the support material.

5. A material according to claim 1, wherein the divalent metal ion is selected from magnesium, zinc and iron ions.

6. A catalyst and/or absorbent obtained by treatment of a material according to claim 1, wherein the treatment comprises a chemical, thermal and/or hydrothermal treatment.

7. A catalyst on support, comprising a material according to claim 1 and a catalytically active material.

8. A catalyst on support according to claim 7, wherein the catalytically active material is selected from iron, zinc, nickel, cobalt, copper, manganese, molybdenum, precious metals or a mixture of these materials.

9. A material according to claim 1, characterized by sheets which are wavy and which upon analysis by means of transmission electron microscopy seemingly have a higher density than is theoretically possible.

10. A method for the preparation of a material according to claim 1, wherein the pH of a suspension of silicon dioxide particles in a solution of the divalent metal ions to be incorporated in the octahedrally surrounded layer is raised at elevated temperature to a value at which complete or substantially complete precipitation of the divalent metal takes place.

11. A method according to claim 10, wherein the temperature of the suspension is adjusted to above 60° C.

12. A method according to claim 10, wherein the pH is raised to a value above 5.0, preferably above 5.5.

13. A method according to claim 10, wherein the resultant solid material is separated from the liquid, followed by washing, drying, and optionally thermally pretreating at a temperature of approximately 700° C. at a maximum.

14. A method according to claim 10, wherein the pH is raised by injection of a solution of an alkali metal hydroxide or an alkali metal carbonate into the suspension of the silicon dioxide.

15. A method according to claim 10, wherein the nitrite of an alkali metal is dissolved in the suspension of the silicon dioxide and then the suspension, whilst closed off from molecular oxygen, is heated at a temperature above 60° C.

16. A method according to claim 10, wherein urea or another compound with hydrolyzable amino groups is dissolved in the suspension and the suspension is heated at a temperature above approximately 60° C.

17. A method for the preparation of a catalyst on support, comprising a material according to claim 20 and a catalytically active material;
the catalytically active material is selected from iron, zinc, nickel, cobalt, copper, manganese, molybdenum, precious metals or a mixture of these materials;
the catalytically active material being applied after a process for the preparation of a material comprising raising the pH of a suspension of silicon dioxide particles in a solution of the divalent metal ions to be incorporated in the octahedrally surrounded layer at elevated temperature to a value at which complete or substantially complete precipitation of the divalent metal takes place.

18. A method according to claim 17, wherein the active material is different than the divalent metal ion for the preparation of the support.

19. Use of a catalyst or material according to claim 1 as support material for catalytically active material, as additive for plastics or in interference pigment.

20. A material according to claim 2, wherein:
the content of free silica is less than 10 wt. %, preferably less than 1 wt. % of the support material;
the content of aluminum is less than 10 wt. %, preferably less than 1 wt. % of the support material;
the divalent metal ion is selected from magnesium, zinc and iron ions.

21. A catalyst and/or absorbent obtained by treatment of a material according to claim 20, wherein the treatment comprises a chemical, thermal and/or hydrothermal treatment.

22. A catalyst on support, comprising a material according to claim 20 and a catalytically active material;
the catalytically active material is selected from iron, zinc, nickel, cobalt, copper, manganese, molybdenum, precious metals or a mixture of these materials.

23. A material according to claim 20, characterized by sheets which are wavy and which upon analysis by means of transmission electron microscopy seemingly have a higher density than is theoretically possible.

24. A material according to claim 21, characterized by sheets which are wavy and which upon analysis by means of transmission electron microscopy seemingly have a higher density than is theoretically possible.

25. A material according to claim 22, characterized by sheets which are wavy and which upon analysis by means of transmission electron microscopy seemingly have a higher density than is theoretically possible.

26. A method for the preparation of a material according to claim 20, wherein:
the pH of a suspension of silicon dioxide particles in a solution of the divalent metal ions to be incorporated in the octahedrally surrounded layer is raised at elevated temperature
to a value at which complete or substantially complete precipitation of the divalent metal takes place;
the temperature of the suspension is adjusted to above 60° C. and the pH is raised to a value above 5.0, preferably above 5.5;
the resultant solid material is separated from the liquid, followed by washing, drying, and optionally thermally pretreating at a temperature of approximately 700° C. at a maximum;
the pH is raised by injection of a solution of an alkali metal hydroxide or an alkali metal carbonate into the suspension of the silicon dioxide;
the nitrite of an alkali metal is dissolved in the suspension of the silicon dioxide and then the suspension, whilst closed off from molecular oxygen, is heated at a temperature above 60° C.;
urea or another compound with hydrolyzable amino groups is dissolved in the suspension and the suspension is heated at a temperature above approximately 60° C.

27. Use of a catalyst or material according to claim 9 as support material for catalytically active material, as additive for plastics or in interference pigment.

28. Use of a catalyst or material according to claim 20 as support material for catalytically active material, as additive for plastics or in interference pigment.

29. Use of a catalyst or material according to claim 21 as support material for catalytically active material, as additive for plastics or in interference pigment.

30. Use of a catalyst or material according to claim 22 as support material for catalytically active material, as additive for plastics or in interference pigment.

31. The method of claim 17 further comprising:
adjusting the temperature of the suspension to above 60° C. and raising the pH to a value above 5.0, preferably above 5.5;
separating the resultant solid material from the liquid, followed by washing, drying, and optionally thermally pretreating at a temperature of approximately 700° C. at a maximum;
raising the pH by injection of a solution of an alkali metal hydroxide or an alkali metal carbonate into the suspension of the silicon dioxide;
dissolving the nitrite of an alkali metal in the suspension of the silicon dioxide and then heating the suspension, whilst closed off from molecular oxygen, at a temperature above 60° C.; and
dissolving urea or another compound with hydrolyzable amino groups in the suspension and heating the suspension at a temperature above approximately 60° C.
